(19) United States
(12) Patent Application Publication
(10) Pub. No.: US 2014/0219237 A1
(43) Pub. Date: Aug. 7, 2014

(54) Method and Apparatus for Establishing a Time-Frequency Reference Signal Pattern Configuration in a Carrier Extension or Carrier Segment

(71) Applicants: Gilles Charbit, Farnborough (GB); Erlin Zeng, Beijing (CN); Haiming Wang, Beijing (CN); Chunyan Gao, Beijing (CN)

(72) Inventors: Gilles Charbit, Farnborough (GB); Erlin Zeng, Beijing (CN); Haiming Wang, Beijing (CN); Chunyan Gao, Beijing (CN)

(73) Assignee: Broadcom Corporation, Irvine, CA (US)

(21) Appl. No.: 14/123,770

(22) PCT Filed: Jun. 7, 2011
(86) PCT No.: PCT/CN2011/075381

§ 371 Date: Mar. 13, 2014

(51) Int. Cl. H04L 5/00; H04W 24/10

(52) U.S. Cl. CPC H04L 5/005; H04L 5/0005; H04W 24/10
USPC 370/330

(57) ABSTRACT

Methods, apparatus and computer program products are provided for establishing a time-frequency reference signal pattern configuration in a carrier extension or a carrier segment, such as for cell-specific reference signals (CRS) and/or demodulation reference signals (DM RS). One method includes receiving information regarding a time-frequency reference signal pattern configuration in a carrier extension or carrier segment. The time-frequency reference signal pattern configuration defines a subframe to include a reference signal based upon a time density parameter and defines a resource element to be utilized within the subframe based upon a frequency density parameter. This method also includes receiving reference signals pursuant to the time-frequency reference signal pattern configuration such that reference signals have a coherence time T_{coh} with at least one subframe including a reference signal in the CE or CS per T_{coh} and a coherence bandwidth B_{coh} with at least one resource element containing a reference signal per B_{coh}.

### TECHNOLOGICAL FIELD

Embodiments of the present invention relate generally to communications technology and, more particularly, to the establishment of a time-frequency reference signal pattern configuration in a carrier extension or carrier segment.

### BACKGROUND

Carrier aggregation is a combination of two or more cells or component carriers (CCs) operating on different frequencies in order to provide a broader transmission bandwidth for a mobile terminal. The component carriers that are aggregated in accordance with carrier aggregation include a primary cell and one or more secondary cells. Although component carriers are backwards compatible relative to prior releases, such as to Releases 8, 9 or 10 of the long term evolution (LIE) specification, non-backwards compatible elements, such as carrier segments (CS) and carrier extensions (CE), have been proposed. A carrier extension and/or a carrier segment may be useful for various purposes including improvements in spectral efficiency and scenarios involving bandwidth extension by narrow bandwidths. A carrier extension and/or a carrier segment may also be useful in instances in which the actual bandwidth allocation does not match the legacy system bandwidth numerology, such as the LTE Release 8 system bandwidth numerology.

As shown in FIG. 1a, a carrier segment may be a contiguous bandwidth extension of a backwards compatible component carrier. The backwards compatible component carrier is designated as the normal carrier or stand-alone carrier in FIG. 1a. The carrier segment is part of the combined carrier and shares a single transport block (TB) with a maximum of 110 radio blocks scheduled, has a single physical downlink control channel (PDCCH) for resource allocation and a single hybrid authorization request (HARQ) unit with the component carrier. Thus, the carrier segment may not be separately activated or deactivated relative to the component carrier.

A carrier segment may utilize a guardband between two component carriers, either with the same or a different duplex mode. A carrier segment may be either semi-statically or statically configured with a semi-static configuration allowing for flexible configuration of the bandwidth.

As shown in FIG. 1b, a carrier extension is part of a component carrier set in which at least one of the carriers in the set is a backwards compatible component carrier. In contrast to a carrier segment, a carrier extension is an independent carrier without system information that is configured only as a secondary cell for all of the mobile terminals. A carrier extension has a transport block with a maximum of 110 radio blocks scheduled and a HARQ unit that is different than those of the other carriers in the component carrier set. In this regard, the backwards compatible component associated with the carrier extension is configured as a primary cell and has its own transport block with a maximum of 110 radio blocks scheduled and a HARQ unit. A carrier extension may be utilized for various purposes, including inter-cell interference coordination (ICIC) in an unlicensed band, frequency division duplex (FDD)/time division duplex (TDD) carrier aggregation, global system for mobile communications (GSM) re-farming, etc. As the carrier extension is an independent carrier, the carrier extension will need activation and deactivation. Additionally, a cell-specific reference signal (CRS) may be necessary for the carrier extension to allow the mobile terminal to obtain measurements and provide a report informing the base station as to whether the carrier extension is available.

In this regard, a CRS on a carrier extension or carrier segment may be useful for a variety of reasons including use by a mobile terminal for synchronization, channel estimation, automatic frequency control (AFC), channel state information (CSI) such as a channel quality indicator (CQI) and a pre-coding matrix indicator (PMI), and reference signal received power (RSRP) and reference signal received quality (RSRQ) for radio resource management (RRM) measurement, etc. More particularly, for an interband carrier extension, a CRS may be required for AFC for Doppler-based frequency offset correction, which may be assumed to be different and un-correlated in non-contiguous bands. If available, a CRS may also be utilized to track and correct frequency drift in non-contiguous bands for synchronization purposes. The frequency drift may be due to the accuracy of the crystal component used to generate the reference clock in the mobile terminal. In this regard, a larger drift may occur in a higher frequency band than in a lower frequency band. Because a reference clock utilizes a sampling rate to generate a timing reference, the interband-dependent frequency drift may cause the time drift if uncorrected. Further, a CRS may be required for CSI measurement, such as CQI and/or PMI, for transmission modes #1-#8 and also for channel estimation for the transmission modes #1-#8.

Additionally, for an intraband carrier extension or carrier segment, the CRS utilized to track frequency drift and Doppler-induced frequency offset may be correlated for the contiguous bands. Hence, CRS may primarily be required for CSI measurements for transmission modes #1-#8, and also for channel estimation for transmission modes #1-#8. While CRS may be advantageous on a carrier extension and/or a carrier segment, efficient scheduling techniques for the CRS on the carrier extension and/or carrier segment could be improved.

### BRIEF SUMMARY

Methods, apparatus and computer program products are provided according to an example embodiment for establishing a time-frequency reference signal pattern configuration in a carrier extension or a carrier segment. For example, the methods, apparatus and computer program products of one embodiment may establish a time-frequency cell-specific reference signal (CRS) pattern configuration and/or a time-frequency demodulation reference signal (DM RS) pattern configuration in a carrier extension or a carrier segment.

In one embodiment, a method is provided that includes receiving information regarding a time-frequency reference signal pattern configuration in a carrier extension (CE) or a carrier segment (CS). The time-frequency reference signal pattern configuration defines a subframe to include a reference signal based upon a time density parameter N_{TD} and defines a resource element to be utilized within the subframe based upon a frequency density parameter N_{FD}. The method of this embodiment also includes receiving reference signals in accordance with the time-frequency reference signal pattern configuration such that the reference signals have a coherence time T_{coh} with at least one subframe including a reference signal in the CE or CS per T_{coh} and a coherence bandwidth B_{coh} with at least one resource element containing a reference signal per B_{coh}.

In another embodiment, an apparatus is provided that includes at least one processor and at least one memory including computer program code with the at least one memory and the computer program code being configured to, with the at least one processor, cause the apparatus at least to receive information regarding a time-frequency reference signal pattern configuration in a carrier extension (CE) or a carrier segment (CS). The time-frequency reference signal pattern configuration defines a subframe to include a reference signal based upon a time density parameter N_{TD} and defines a resource element to be utilized within the subframe based upon a frequency density parameter N_{FD}. The at least one memory and the computer program code of this embodiment are also configured to, with the at least one processor, cause the apparatus to receive reference signals in accordance with the time-frequency reference signal pattern configuration such that the reference signals have a coherence time T_{coh} with at least one subframe including a reference signal in the CE or CS per T_{coh} and a coherence bandwidth B_{coh} with at least one resource element containing a reference signal per B_{coh}.

In a further embodiment, a computer program product is provided that includes at least one computer-readable storage medium having computer-executable program code instructions stored therein with the computer-executable program code instructions including program code instructions for receiving information regarding a time-frequency reference signal pattern configuration in a carrier extension (CE) or a carrier segment (CS). The time-frequency reference signal pattern configuration defines a subframe to include a reference signal based upon a time density parameter N_{TD} and defines a resource element to be utilized within the subframe based upon a frequency density parameter N_{FD}. The computer-executable program code instructions of this embodiment also include program code instructions for receiving reference signals in accordance with the time-frequency reference signal pattern configuration such that the reference signals have a coherence time T_{coh} with at least one subframe including a reference signal in the CE or CS per T_{coh} and a coherence bandwidth B_{coh} with at least one resource element containing a reference signal per B_{coh}.

In yet another embodiment, an apparatus is provided that includes means for receiving information regarding a time-frequency reference signal pattern configuration in a carrier extension (CE) or a carrier segment (CS). The time-frequency reference signal pattern configuration defines a subframe to include a reference signal based upon a time density parameter N_{TD} and defines a resource element to be utilized within the subframe based upon a frequency density parameter N_{FD}. The apparatus of this embodiment also includes means for receiving reference signals in accordance with the time-frequency reference signal pattern configuration such that the reference signals have a coherence time T_{coh} with at least one subframe including a reference signal in the CE or CS per T_{coh} and a coherence bandwidth B_{coh} with at least one resource element containing a reference signal per B_{coh}.

In one embodiment, a method is provided that includes defining a time-frequency reference signal pattern configuration in a carrier extension (CE) or a carrier segment (CS) to have density parameters. The density parameters include a time density parameter N_{TD} that defines a subframe to include a reference signal and a frequency density parameter N_{FD} that defines a resource element to be utilized within the subframe. The method of this embodiment also includes coordinating, in an instance in which a neighboring base station has a time-frequency reference signal pattern configuration with a respective density parameter that is the same, the reference signal patterns by offsetting the reference signal pattern.

In another embodiment, an apparatus is provided that includes at least one processor and at least one memory including computer program code with the at least one memory and the computer program code being configured to, with the at least one processor, cause the apparatus at least to define a time-frequency reference signal pattern configuration in a carrier extension (CE) or a carrier segment (CS) to have density parameters. The density parameters include a time density parameter N_{TD} that defines a subframe to include a reference signal and a frequency density parameter N_{FD} that defines a resource element to be utilized within the subframe. The at least one memory and the computer program code of this embodiment are also configured to, with the at least one processor, cause the apparatus to coordinate, in an instance in which a neighboring base station has a time-frequency reference signal pattern configuration with a respective density parameter that is the same, the reference signal patterns by offsetting the reference signal pattern.

In a further embodiment, a computer program product is provided that includes at least one computer-readable storage medium having computer-executable program code instructions stored therein with the computer-executable program code instructions including program code instructions for defining a time-frequency reference signal pattern configuration in a carrier extension (CE) or a carrier segment (CS) to have density parameters. The density parameters include a time density parameter N_{TD} that defines a subframe to include a reference signal and a frequency density parameter N_{FD} that defines a resource element to be utilized within the subframe. The computer-executable program code instructions of this embodiment also include program code instructions for coordinating, in an instance in which a neighboring base station has a time-frequency reference signal pattern configuration with a respective density parameter that is the same, the reference signal patterns by offsetting the reference signal pattern.

In yet another embodiment, an apparatus is provided that includes means for defining a time-frequency reference signal pattern configuration in a carrier extension (CE) or a carrier segment (CS) to have density parameters. The density parameters include a time density parameter N_{TD} that defines a subframe to include a reference signal and a frequency density parameter N_{FD} that defines a resource element to be utilized within the subframe. The apparatus of this embodiment also includes means for coordinating, in an instance in which a neighboring base station has a time-frequency reference signal pattern configuration with a respective density parameter that is the same, the reference signal patterns by offsetting the reference signal pattern.

In one embodiment, a method is provided that includes receiving a report of a channel quality indicator (CQI) or a precoding matrix indicator (PMI) for a subband Sᵢ for each of a plurality of channel state information (CSI) measurement time intervals T_{Δ}. The method of this embodiment also includes determining a number n of consecutive intervals T_{Δ} over which the report of the CQI or the PMI remains consistent and determining a subband CSI measurement report periodicity for the subband Sᵢ based upon a product of the number n and the interval T_{Δ}.

In another embodiment, an apparatus is provided that includes at least one processor and at least one memory including computer program code with the at least one memory and the computer program code being configured to, with the at least one processor, cause the apparatus at least to receive a report of a channel quality indicator (CQI) or a precoding matrix indicator (PMI) for a subband Sᵢ for each of a plurality of channel state information (CSI) measurement time intervals T_{Δ}. The at least one memory and the computer program code of this embodiment are also configured to, with the at least one processor, cause the apparatus to determine a number n of consecutive intervals T_{Δ} over which the report of the CQI or the PMI remains consistent and to determine a subband CSI measurement report periodicity for the subband Sᵢ based upon a product of the number n and the interval T_{Δ}.

In a further embodiment, a computer program product is provided that includes at least one computer-readable storage medium having computer-executable program code instructions stored therein with the computer-executable program code instructions including program code instructions for receiving a report of a channel quality indicator (CQI) or a precoding matrix indicator (PMI) for a subband Sᵢ for each of a plurality of channel state information (CSI) measurement time intervals T_{Δ}. The computer-executable program code instructions of this embodiment also include program code instructions for determining a number n of consecutive intervals T_{Δ} over which the report of the CQI or the PMI remains consistent and program code instructions for determining a subband CSI measurement report periodicity for the subband Sᵢ based upon a product of the number n and the interval T_{Δ}.

In yet another embodiment, an apparatus is provided that includes means for receiving a report of a channel quality indicator (CQI) or a precoding matrix indicator (PMI) for a subband Sᵢ for each of a plurality of channel state information (CSI) measurement time intervals T_{Δ}. The apparatus of this embodiment also includes means for determining a number n of consecutive intervals T_{Δ} over which the report of the CQI or the PMI remains consistent and means for determining a subband CSI measurement report periodicity for the subband Sᵢ based upon a product of the number n and the interval T_{Δ}.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described example embodiments of the invention in general terms, reference will now be made to the accompanying drawings, which are not necessarily drawn to scale, and wherein:

FIGS. 1a and 1b illustrate a channel segment and a channel extension, respectively;

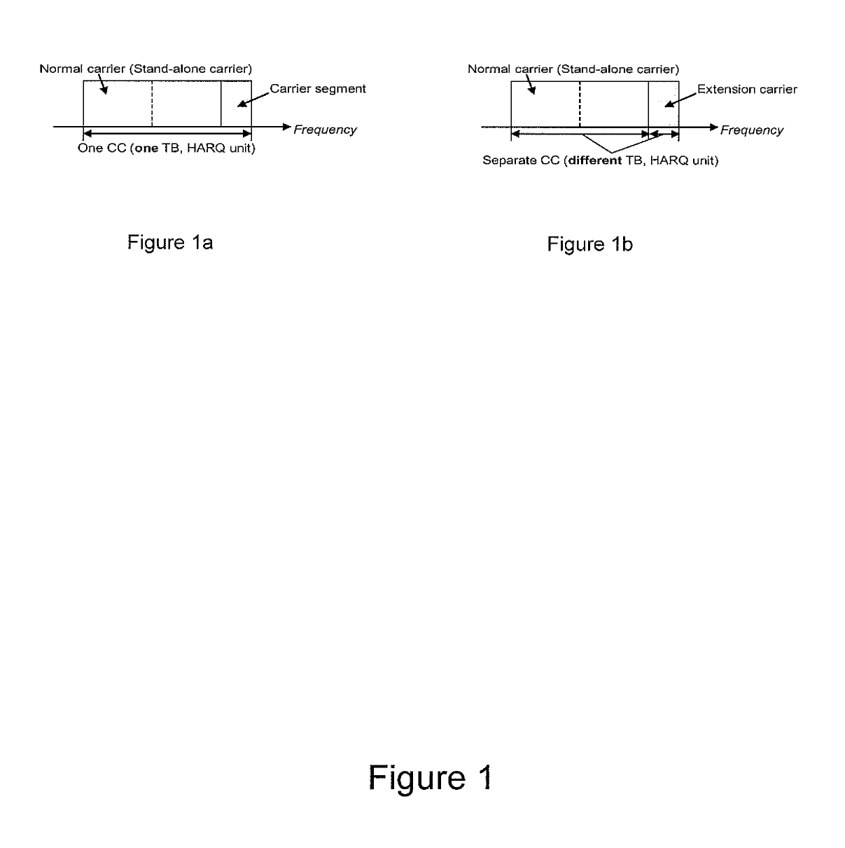

FIG. 2 illustrates a system including a mobile terminal and a base station configured to support communications in accordance with one embodiment of the present invention;

FIG. 3 is a block diagram of a mobile terminal in accordance with one embodiment of the present invention;

FIG. 4 is a block diagram of a base station or other network element in accordance with one embodiment of the present invention;

FIG. 5 is a flow chart illustrating the operations performed from the perspective of a mobile terminal in accordance with one embodiment of the current invention;

FIG. 6 illustrates a CRS pattern for a channel extension or a channel segment in accordance with one embodiment of the present invention;

FIG. 7 illustrates a CRS pattern for a backwards compatible component carrier for each of two antenna ports in accordance with Release 8 of the LTE specification;

FIG. 8 is a flow chart illustrating the operations performed from the perspective of a base station or other network element in accordance with one embodiment of the present invention; and

FIG. 9 is a flow chart illustrating the operations performed from the perspective of a base station or other network element in accordance with another embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

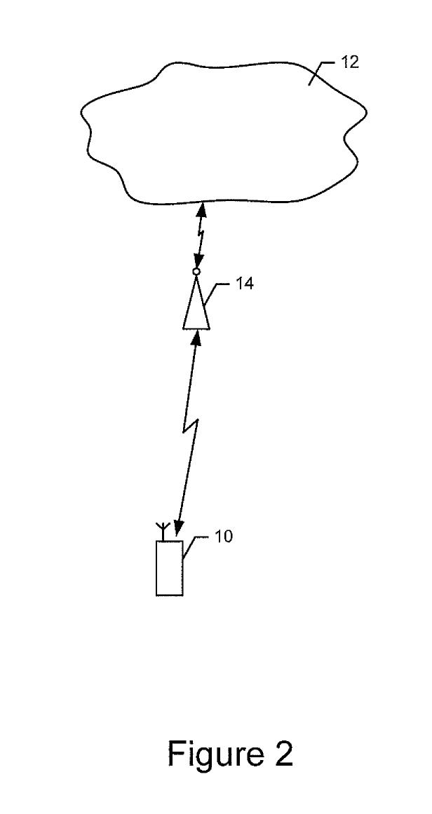

A method, apparatus and computer program product are disclosed for establishing a time-frequency reference signal pattern configuration in a carrier extension or a carrier segment. In this regard, the method, apparatus and computer program product of some example embodiments define the time-frequency reference signal pattern configuration in a carrier extension or a carrier segment for cell-specific reference signals (CRS) and/or for demodulation reference signals (DM RS). Although the method, apparatus and computer program product may be implemented in a variety of different systems, one example of such a system is shown in FIG. 2, which includes a first communication device (e.g., mobile terminal 10) that is capable of communication with a network 12 (e.g., a core network) via a base station (e.g., an evolved Node B (eNB)). While the network may be configured in accordance with LTE or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 12 may include a collection of various different nodes, devices or functions that may be in communication with each other via corresponding wired and/or wireless interfaces. For example, the network may include one or more base stations 14, each of which may serve a coverage area divided into one or more cells. The base stations or other communication node could be, for example, part of one or more cellular or mobile networks or public land mobile networks (PLMNs). In turn, other devices such as processing devices (e.g., personal computers, server computers or the like) may be coupled to the mobile terminal and/or other communication devices via the network.

A communication device, such as the mobile terminal 10 (also known as user equipment (UE)), may be in communication with other communication devices or other devices via the base station 14 and, in turn, the network 12. In some cases, the communication device may include an antenna for transmitting signals to and for receiving signals from a base station.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 12.

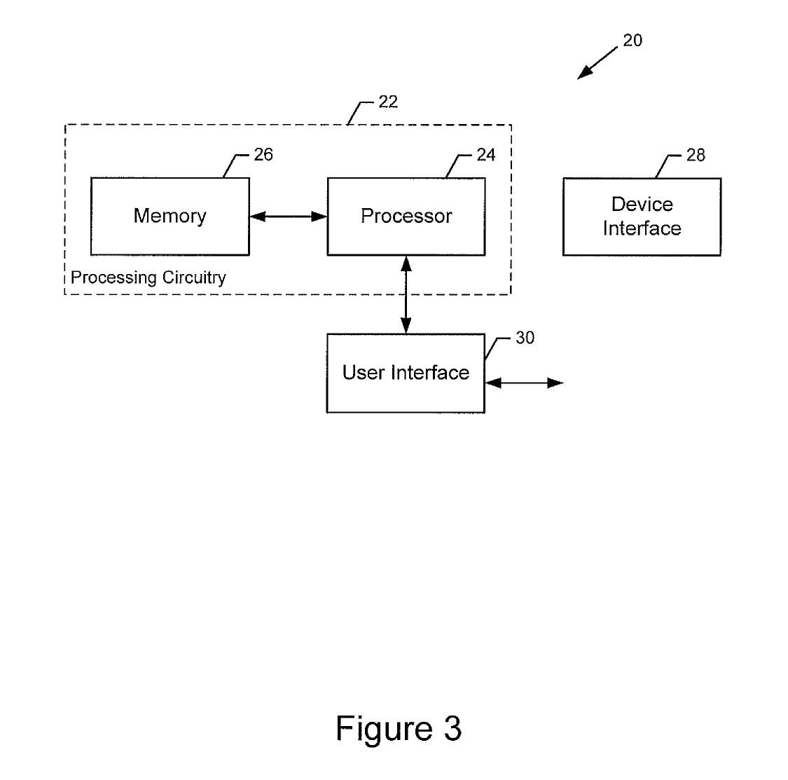

In one embodiment, for example, the mobile terminal 10 may be embodied as or otherwise include an apparatus 20 as generically represented by the block diagram of FIG. 3. In the context of a mobile terminal, the apparatus may be configured to communicate with the base station 14 in order to establish a time-frequency reference signal pattern configuration, such as for CRS and/or DM RS. While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms.

The device interface 28 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 12 and/or any other device or module in communication with the processing circuitry 22. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

As noted above, a base station 14 or other network entity may be configured to communicate with the mobile terminal 10. In some cases, the base station may include an antenna or an array of antennas for transmitting signals to and for receiving signals from the mobile terminal. The base station may include one or more processors that may define processing circuitry either alone or in combination with one or more memories. The processing circuitry may utilize instructions stored in the memory to cause the base station to operate in a particular way or execute specific functionality when the instructions are executed by the one or more processors. The base station may also include communication circuitry and corresponding hardware/software to enable communication with the mobile terminal and/or the network 12.

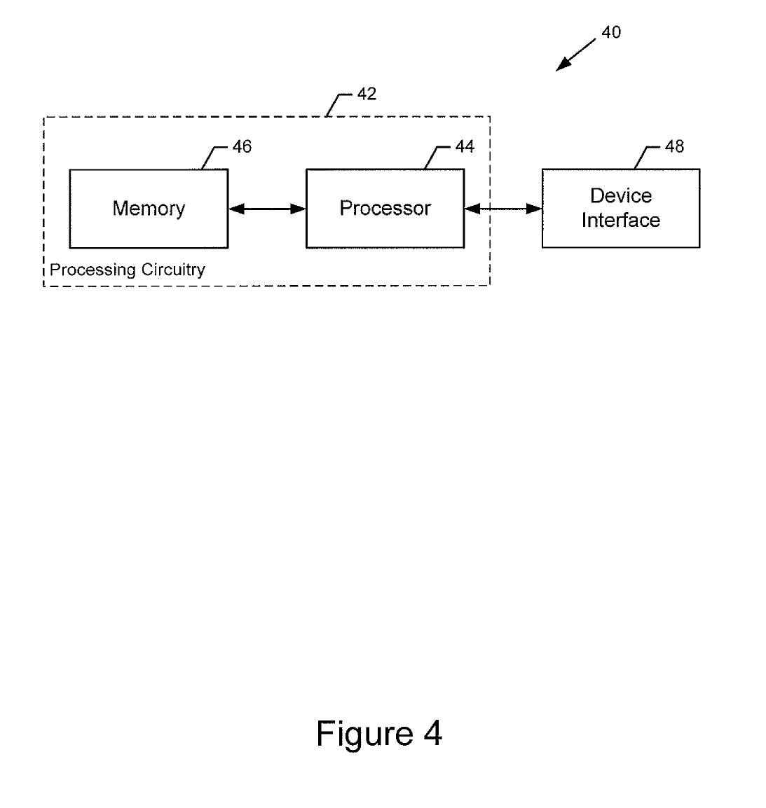

In one embodiment, the base station 14, such as an eNB, a home NB, an access point or the like, may be embodied as or otherwise include an apparatus 40 as generically represented by the block diagram of FIG. 4. While the apparatus may be employed, for example, by a base station, it should be noted that the components, devices or elements described below may not be mandatory and thus some may be omitted in certain embodiments. Additionally, some embodiments may include further or different components, devices or elements beyond those shown and described herein.

As shown in FIG. 4, the apparatus 40 may include or otherwise be in communication with processing circuitry 42 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 42 may include a processor 44 and memory 46 that may be in communication with or otherwise control a device interface 48. As such, the processing circuitry may be embodied as a circuit chip (e.g., an integrated circuit chip) configured (e.g., with hardware, software or a combination of hardware and software) to perform operations described herein. However, in some embodiments taken in the context of the base station, the processing circuitry may be embodied as a portion of a base station or other network entity.

The device interface 48 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 12 and/or any other device or module in communication with the processing circuitry 42. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 46 may include one or more non-transitory memory devices such as, for example, volatile and/or non-volatile memory that may be either fixed or removable. The memory may be configured to store information, data, applications, instructions or the like for enabling the apparatus 40 to carry out various functions in accordance with example embodiments of the present invention. For example, the memory could be configured to buffer input data for processing by the processor 44. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 44 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 46 or otherwise accessible to the processor. As such, whether configured by hardware or by a combination of hardware and software, the processor may represent an entity (e.g., physically embodied in circuitry—in the form of processing circuitry 42) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

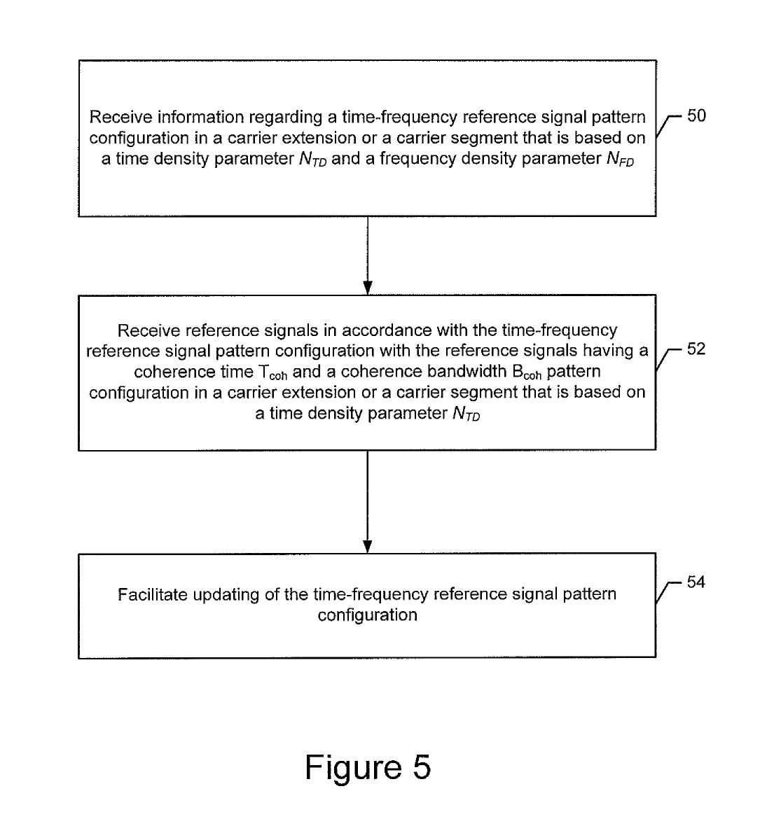

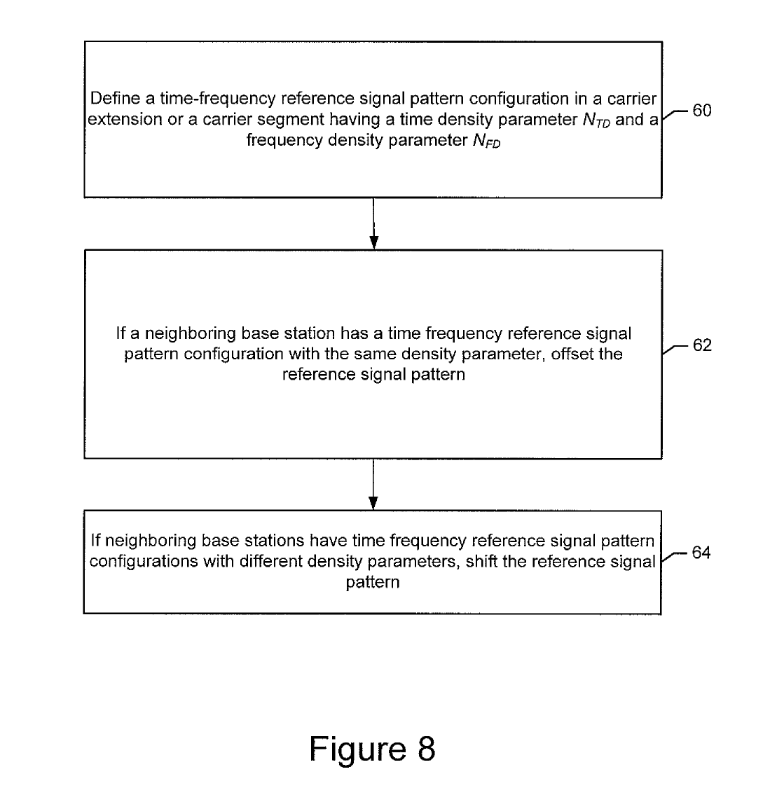

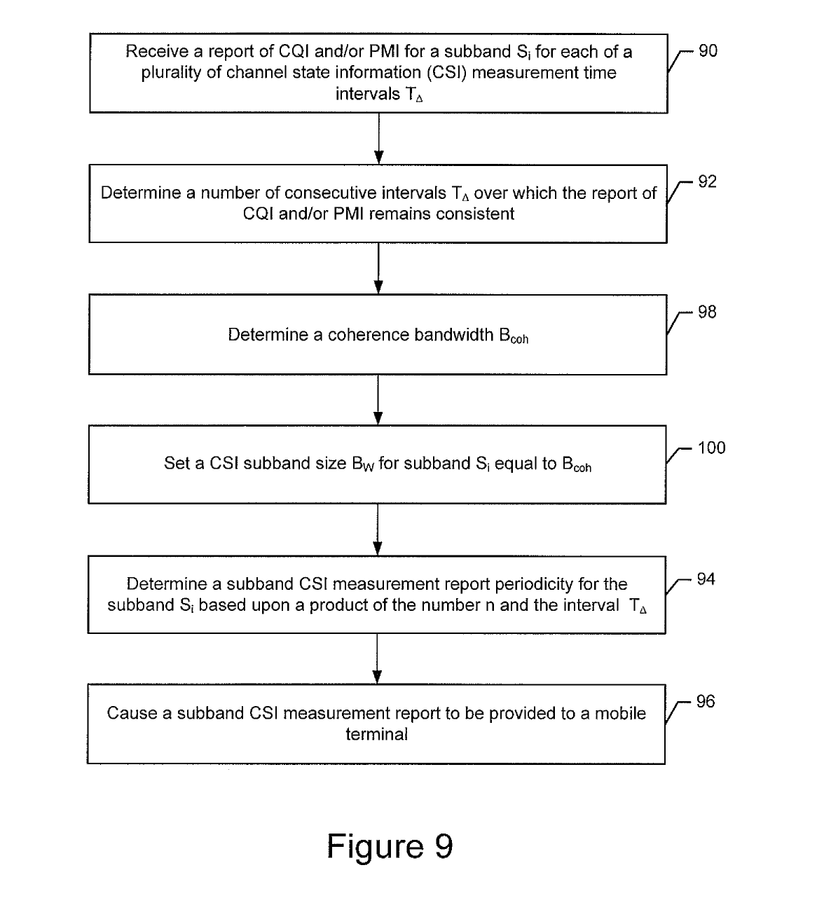

Referring now to FIGS. 5, 8 and 9, flowcharts illustrating the operations performed by a method, apparatus and computer program product, such as apparatus 20 of FIG. 3 in regards to FIG. 5 and apparatus 40 of FIG. 4 in regards to FIGS. 8 and 9, in accordance with one embodiment of the present invention are illustrated. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 5, 8 and 9, when executed, convert a computer or processing circuitry into a particular machine configured to perform an example embodiment of the present invention. Accordingly, the operations of each of FIGS. 5, 8 and 9 define an algorithm for configuring a computer or processing circuitry, e.g., processor 24 of FIG. 3 in regards to the operations of FIG. 5 and processor 44 of FIG. 4 in regards to the operations of FIGS. 8 and 9, to perform an example embodiment. In some cases, a general purpose computer may be provided with an instance of the processor which performs the algorithm of a respective one of FIGS. 5, 8 and 9 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

According to embodiments of the present invention, a technique for semi-statically configuring a reference signal, e.g., CRS, pattern for a carrier extension and/or carrier segment is provided, as shown in FIG. 5. In this regard, the CRS pattern for a carrier extension and/or carrier segment may be configured in the frequency domain and time domain so as to balance the CRS overhead, such as the CRS-based estimates for synchronization tracking, AFC, channel estimation for transmission modes #1-#8 and CRS-based CSI measurements of transmission modes #1-#8, and interference from the reference signals. As shown in FIG. 5 from the perspective of a mobile terminal, an apparatus 20 may include means, such as the processing circuitry 22, the processor 24, the device interface 28 or the like, for receiving information regarding a time-frequency reference signal pattern configuration in a carrier extension or a carrier segment. See operation 50. The time-frequency reference signal pattern configuration may be provided by a base station 14 and is based on a time density parameter N_{TD} and a frequency density parameter N_{FD}. It is noted that the time frequency reference signal pattern configuration may be provided for various reference signals, such as CRS and/or DM RS. For purposes of example, but not of limitation, the following discussion will primarily describe a time-frequency CRS pattern configuration, although an analogous time frequency reference signal pattern configuration may be provided for a DM RS.

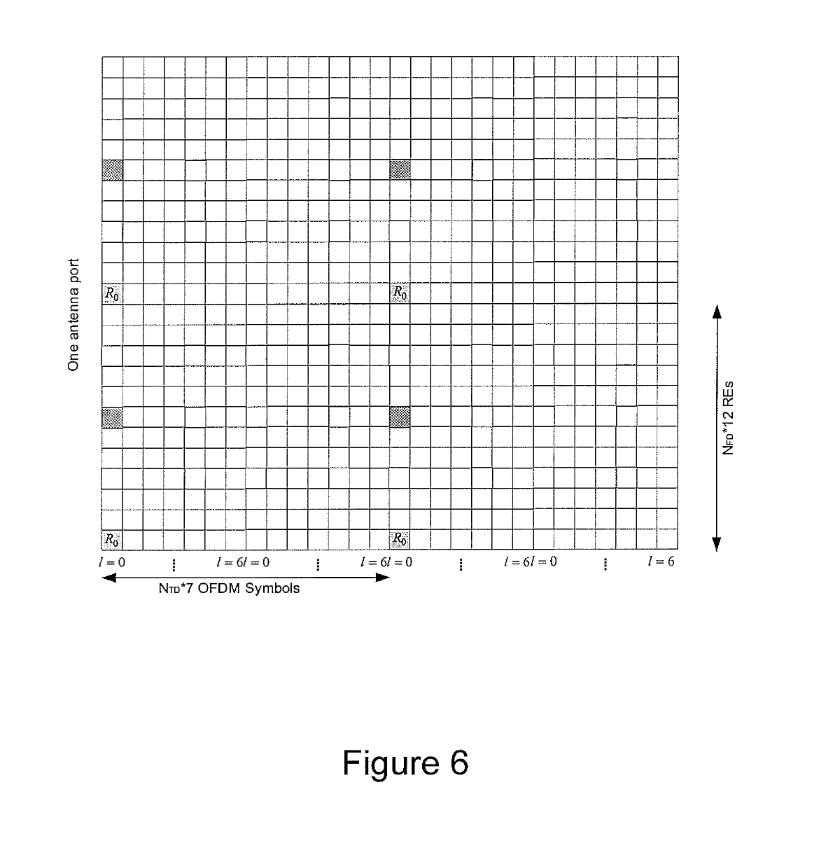

In this regard, the time frequency CRS pattern configuration may define a CRS time density parameter N_{TD} and a CRS frequency density parameter N_{FD}. Based upon the density parameters, the CRS configuration on a channel extension and/or a channel segment may be defined. In this regard, the subframes that include the reference signals may be spaced apart in a manner based upon the CRS time density parameter N_{TD}. In one embodiment in which N_{TD}=2, reference signals may be included in every N_{TD}*7 downlink (DL) subframe as shown in FIG. 6. Additionally, within a subframe that includes a reference signal, the reference signals may be spaced apart by a number of resource elements (REs) that is based upon the CRS frequency density frame N_{FD}. In the embodiment of FIG. 6 in which N_{FD}=2, for example, a reference signal may be provided every N_{FD}*6 resource elements.

It is noted that FIG. 6 illustrates the CRS pattern for one antenna port, e.g., antenna port #0. In FIG. 6, the REs that are cross-hatched do not include CRS for antenna port #0, but may include CRS for other antenna ports, e.g., antenna port #1.

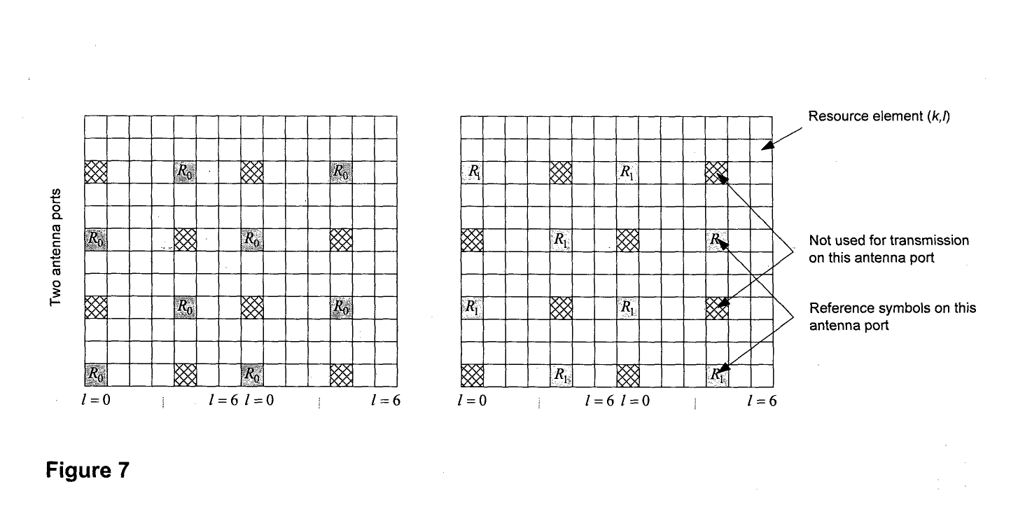

The CRS pattern configuration on a channel extension and/or a channel segment may be relatively sparse relative to the CRS configuration on a backwards compatible component carrier. In this regard, the CRS pattern configuration on a channel extension and/or a channel segment as shown in FIG. 6 for one antenna port may be compared to the CRS pattern configuration on a backwards compatible component carrier according to the LTE Release 8 specification as shown in FIG. 7 for two antenna ports. In this regard, FIG. 7 illustrates that a CRS in accordance with the LTE Release 8 specification is included in DL subframes #0 and #4 with every sixth resource element containing the CRS. Hence the CRS overhead for antenna port #0 or #1 in accordance with the LTE Release 8 specification is 2/14*2/12=2.38%. In contrast, the CRS pattern for port #0 for a channel extension or channel segment in accordance with one embodiment of the present invention is shown in FIG. 6 with the CRS being present in every N_{TD}*7 DL subframe and, within each of those subframes, in every N_{FD}*6 REs. Hence, as an example, with N_{TD}=2 and N_{FD}=2, the CRS overhead for antenna port #0 is 1/(N_{TD}*7)*2/(N_{FD}*12) equals 1/(2*7)*2/(2*12) equals 0.6% or 1.2% for both antenna ports #0 and #1. This example therefore illustrates an approximate 75% CRS overhead reduction in the channel extension or the channel segment in comparison to the CRS overhead for antenna ports #0 and #1 configured in accordance with the LTE Release 8 specification.

Additionally, the subframes of FIG. 6 that are configured in accordance with one embodiment of the present invention include far fewer CRSs than provided in accordance with the LTE Release 8 specification and, indeed, is almost blank relative to the CRSs for LTE Release 8 CRS on a backwards compatible component carrier. As such, the reduction in the number of CRSs may advantageously reduce inter-CRS interference on the channel extension or channel segment. Additionally, DL measurement gaps can be readily created in accordance with one embodiment of the present invention during subframes devoid of CRS on a channel extension or channel segment based on the value of N_{TD}. Within these measurement gaps, CRS-based measurements and/or non-cellular measurements on unlicensed-exempt bands may be conducted.

In a manner consistent with the time-frequency reference signal pattern configuration, the apparatus 20 may include means, such as the processing circuitry 22, the processor 24, the device interface 28 or the like, for receiving reference signals in accordance with the time-frequency reference signal pattern configuration. See operation 52 of FIG. 5. Based on the time-frequency reference signal pattern configuration, the reference signals may have a semi-statically configured time domain (TD) and frequency domain (FD) CRS density that is based on a coherence time T_{coh} with at least one subframe including a reference signal, such as the CRS, in the channel extension or channel segment per T_{coh} and based on a coherence bandwidth B_{coh} with at least one RE containing a reference signal, such as the CRS, per B_{coh}. Coherence time is related to the Doppler spread and may be approximated as T_{coh} equals 1/f_{d} in which f_{d} is a Doppler spread or Doppler shift. The Doppler shift f_{d}=v*f_{c}/c or v and c are the velocity of the mobile terminal and the speed of light in meters per second, respectively, and f_{c} is the carrier frequency. As an example, assume f_{c}=2 GHz and v equals 3 km/h, the coherence time is 180 ms (e.g., 180 subframes), while at 300 km/h, the coherence time is 1.8 ms (e.g., 1.8 subframes). Coherence bandwidth is related to the delay spread. For example, for an international telecommunication union (ITU) A1 model (indoor office channel), the coherence bandwidth is 4 Mhz.

As shown in operation 54 of FIG. 5, the apparatus 20 may also include means, such as a processing circuitry 22, the processor 24 or the like, for facilitating updating at a time-frequency reference signal pattern configuration. In this regard, the apparatus may include means, such as a processing circuitry, the processor or the like, for estimating the coherence time T_{coh} and the coherence bandwidth B_{coh}. Additionally, the apparatus of this embodiment may include means, such as the processing circuitry, the processor, the device interface 28 or the like, for causing a report of the coherence time and coherence bandwidth to be provided by the base station 14, such as via higher-layer signaling on a backwards compatible component carrier. Based upon the estimated coherence time and estimated coherence bandwidth, the base station may reconsider the time-frequency reference signal pattern configuration and may, in some embodiments, update the time-frequency reference signal pattern configuration. In this regard, the base station may readily change or update the time-frequency reference signal pattern configuration by indication new density parameters, e.g., N_{TD} and/or N_{FD}, to the mobile terminal 10.

The mobile terminals 10 attached to the base station 14 may estimate the coherence time and the coherence bandwidth based on the CRS-based channel estimation on (i) backwards compatible component carriers assuming the channel extension or channel segment is continuous or (ii) the channel extension or channel segment assuming it is initially configured with a time-frequency CRS pattern with sufficient reference signal density. Regardless of the manner in which the coherence time and coherence bandwidth are estimated, the mobile terminal may thereafter report the estimated coherence time and coherence bandwidth to the base station which may, in turn, utilize these estimates for determining if the time-frequency reference signal pattern configuration is to be updated. The frequency-selective best-M average CQI (UE-selected sub-band feedback) or the higher layer configured sub-band feedback CQI reports may allow the base station 14 to compare the values of several adjacent sub-bands to determine if the values are sufficiency consistent (over several sub-frames) in frequency (over several contiguous physical resource blocks (PRBs)) to remain the same or if an updated time-frequency reference signal pattern configuration is merited.

As an alternative to the explicit provision of an estimated coherence time and an estimated coherence bandwidth, the apparatus 20 may include means, such as the a processing circuitry 22, the processor 24, the device interface 28 or the like, for causing CSI measurements, such as CQI and/or PMI, to be provided to the base station 14. At the base station, the apparatus 40 may determine the coherence time and coherence bandwidth in an implicit manner from the CRS-based CQI (or PMI) reports from the attached mobile terminals 10 with the CQI estimated based on the (i) the backward compatible component carrier assuming the channel extension or channel segment is contiguous or (ii) the channel extension or channel segment assuming it is initially configured with a time-frequency CRS pattern with sufficient reference signal density, such as may be determined by comparison to the CRS density specified by Release 8 of the LTE specification. Based upon the CSI measurements and the implicit information regarding the time-frequency reference signal pattern configuration included within the CSI measurements, the base station may update the time-frequency reference signal pattern configuration, if necessary or desired.

In some instances, the CSI measurements provided by a mobile terminal 10 may be un-reliable, such as due to noise, interference, etc. Based on the RSRP measurements on the primary cell, the base station 14 may be aware of the weak signal conditions and may schedule, for example, an LTE Release 8 or LTE Release 10 DM RS and may use time domain packet scheduling only for the cell-edge mobile terminals. In this regard, the central or mid-cell mobile terminals may utilize CRS-based frequency domain packet scheduling with relatively low time-frequency CRS patterns. Alternatively, the base station may schedule CRS for the higher time-frequency patterns and may utilize frequency domain packet scheduling for all of the mobile terminals.

In addition to or instead of establishing or updating of the time-frequency reference signal pattern configuration based upon feedback from the mobile terminal 10, a base station 14, such as a home eNB, may configure the channel extension and/or channel segment in a predefined manner for local area transmission purposes. In this regard, a relatively large coherence time, such as for low-mobility mobile terminals, and a relatively large coherence bandwidth, such as due to a small delay spread as a result of short range transmissions, may be assumed.

Referring now to FIG. 8, a technique for establishing a downlink measurement configuration based on a configured reference signal, e.g., CRS, pattern is illustrated and described below. In this regard, DL measurement gaps on a backwards compatible carrier are normally based on scheduling solutions that mute downlink sub-frames, that is, by issuing no DL/UL grants via the PDCCH and no data via the physical downlink shared channel (PDSCH), resulting in a virtually blank subframe, but for CRSs that are still transmitted. In accordance with this embodiment of the present invention, DL measurement gaps on channel extensions or channel segments having completely blank sub-frames may be scheduled as described below. In this regard, a base station 14 may mute one or more downlink sub-frames, such as by issuing no DL/UL grants via PDCCH, no physical HARQ indicator channel (PHICH) and no data via PDSCH, according to a time domain muting pattern with inter-base station coordination.

As set forth in operation 60 of FIG. 8, an apparatus 40, such as may be embodied by base station 14, includes means, such as the processing circuitry 42, the processor 44 or the like, for defining a time-frequency reference signal pattern configuration in a carrier extension or carrier segment having a time density parameter N_{td} and a frequency density parameter N_{fd}. The apparatus, such as the processing circuitry or the processor, may be aware of the time-frequency reference signal pattern configuration of one or more neighboring base stations and may compare the time-frequency reference signal pattern configuration of the neighboring base station with the time-frequency reference signal pattern configuration defined by the apparatus.

In an instance in which the neighboring base station has a time-frequency reference signal pattern configuration with the same density parameter as that of the time-frequency reference signal pattern configuration defined by the apparatus 40, the apparatus may include means, such as the processing circuitry 42, the processor 44 or the like, for offsetting the reference signal pattern. See operation 62 of FIG. 8. For example, in an instance in which the neighboring base station has the same CRS time density parameter N_{td}, the apparatus may include means, such as a processing circuitry, the processor or like, for coordinating the CRS patterns in the time domain by establishing a CRS TD sub-frame offset Δ_{CRS} to shift the CRS pattern defined by the apparatus in the time domain. Similarly, if the time-frequency reference signal pattern configuration of the neighboring base station has the same CRS frequency density parameter N_{fd}, the apparatus may include means, such as the processing circuitry, the processor or the like, for coordinating the CRS patterns in the frequency domain by implementing a CRS FD shift Φ_{CRS} to shift the CRS pattern defined by the apparatus in the frequency domain. The frequency domain shift of CRS pattern may be utilized to reduce or minimize inter-CRS interference for CRS-based measurements such as synchronization tracking, AFC and channel estimation for channel extensions and/or channel segments.

The offset described above in conjunction with operation 62 may be a time shift equal to N subframes and may be employed within a common CRS configuration time interval, such as once per coherence time at a minimum or many times per the coherence time assuming that the coherence time remains constant over a relatively large period of time. As such, up to N neighboring base stations 14 in this example embodiment may transmit CRS free of inter-base station interference.

As shown in operation 64 of FIG. 8, in an instance in which the neighboring base station has a time-frequency reference signal pattern configuration that has different density parameters than that defined by the apparatus 40, the apparatus may include means, such as the processing circuitry 42, the processor 44 or the like, for shifting the reference signal pattern. By way of example, in an instance in which the neighboring base station has a different CRS time density parameter N_{TD}, the apparatus may include means, such as a processing circuitry, the processor or like, for coordinating the CRS patterns in the time domain by configuring a CRS TD sub-frame bit map B_{CRS} to shift the CRS pattern defined by the apparatus in the time domain. Similarly, if the time-frequency reference signal pattern configuration of the neighboring base station has a different CRS frequency density parameter N_{fd}, the apparatus may include means, such as the processing circuitry, the processor or the like, for coordinating the CRS patterns in the frequency domain by configuring a CRS FD shift bit map B_{CRS} to shift the CRS pattern defined by the apparatus in the frequency domain.

In contrast to an offset described above in conjunction with operation 62, a bitmap may, instead, define which subframes within an common CRS configuration time interval have CRS transmitted by which neighboring base stations 14. Hence, each neighboring base station will know when only one base station #i transmits CRS in a given subframe #n so that the neighboring base stations can make CRS-based measurements of base station #i. In this regard, the other base stations do not transmit anything during this time period such that there is a completely blank subframe.

The resulting DL measurement gap having blank sub-frames is subject to no inter-cell CRS interference since there is no CRS in these blank sub-frames and may be utilized for various purposes including ICIC measurements and/or non-cellular interference measurements on license-exempt bands for channel extensions and/or channel signals. Although time domain downlink sub-frame muting and termination of associated uplink sub-frames may be required, there is no muting of the CRS required due to the use of time domain coordination of the CRS pattern.

By way of example of coordination in the time domain, N_{TD} may equal 6 for three neighboring base stations, that is, eNB#1, eNB#2 and eNB#3. The three base stations of this example may transmit the CRS on the channel extension or channel segment in offset contiguous subframes 3*i, 3*i+1 and 3*i+2, respectively, as a result of a CRS subframe offset Δ_{CRS} of 0, 1, and 2 subframes, respectively, for the three base stations. As another example, N_{TD} may equal 6, 18 and 12 for three neighboring base stations, that is eNB#1, eNB#2 and eNB#3. Additionally, the CRS subframe bit map B_{CRS} may be (3:8, 9:0, 6:7) in which x:y indicates the N_{TD} and CRS subframe placement within the CRS pattern period, respectively. In this example, eNB#1, eNB#2 and eNB#3 may transmit CRS in the channel extension or channel segment in non-contiguous subframes 3*i+8, 9*i and 6*i+7, respectively, Other combinations are also possible such as 3*i+5, 9*i+2 and 6*i+1 with a B_{CRS} of (3:5, 9:2, 6:1). In this instance, no CRS subframe offset is utilized.

Additionally, by way of example of coordination in the frequency domain, N_{FD} may equal 12, that is, the CRS spacing in the frequency domain is 12 REs, for three neighboring base stations, that is, eNB#1, eNB#2 and eNB#3. The three base stations of this example may transmit the CRS on the channel extension or channel segment with CRS frequency domain shifts of j, j+1, j+2, respectively, as a result of a CRS frequency domain shift Φ_{CRS} of 0, 1, and 2 REs, respectively, for the three base stations. As another example, N_{TD} may equal 12, 6 and 24, that is, the CRS spacing in the frequency domain is 12, 6 and 24 REs, for three neighboring base stations, that is eNB#1, eNB#2 and eNB#3. Additionally, the CRS subframe bit map B_{CRS} may be (12:1, 6:4, 24:3) in which x:y indicates the N_{FD} and CRS RE placement within the CRS pattern period, respectively. In this example, eNB#1, eNB#2 and eNB#3 may transmit CRS in the channel extension or channel segment in non-contiguous REs 12*j+1, 6*j+4 and 24*j+3, respectively, Other combinations are also possible such as 12*j+5, 6*j+2 and 24*j with a B_{CRS} of (12:5, 6:2, 24:0). In this instance, no CRS frequency domain shift is utilized.

Referring now to FIG. 9, a technique for the semi-static configuration of DM RS parameters in sub-band CSI reporting for channel extensions and channel segments is described. In this regard, the apparatus 40 may determine the coherence time experience in the mobile terminal 10-base station 14 link based on a correlation of sub-band-wise reports over a CSI measurement setup time interval C_{csi}_{_{—}}ₛₑₜᵤₚ. In this regard, as shown in operation 90 of FIG. 9 from the perspective of a base station 14, the apparatus may include means, such as the processing circuitry 42, the processor 44, the device interface 48 or the like, for receiving a report of CSI, such as CQI and/or PMI, for a sub-band Sᵢ for each of a plurality of channels of CSI measurement time intervals T_{Δ}. In an instance in which the CSI for sub-band Sᵢ does not change significantly, such as by remaining within a predefined range, changing less than a predefined percent or the like, over a number n of T_{Δ} intervals, the apparatus may include means, such as the processing circuitry, the processor or the like, for defining the coherence time T_{coh} to be greater than n*T_{Δ} where n equals 1, 2, . . . Nₒₚₜᵢₘᵤₘ. In this regard, Nₒₚₜᵢₘᵤₘ corresponds to Tcoh, which is approximately equal to Nₒₚₜᵢₘᵤₘ*T_{Δ} in an instance in which the equality condition is not reached. Nₒₚₜᵢₘᵤₘ may be determined iteratively over several coherence time intervals Tₛₒₕ to take into account measurement reliability, traffic-based interference and the plurality of fading periods.

Upon completion of the CSI measurement setup time interval T_{csi}_{_{—}}ₛₑₜᵤₚ, the apparatus 40 may include means, such as the processing circuitry 42, the processor 44 or the like, for setting the sub-band CSI measurement report density Tᵣₑₚₒᵣₜ, that is, the period in accordance with which CSI, such as CQI and PMI, are reported, to equal Nₒₚₜᵢₘᵤₘ*T_{Δ}, which, in turn, can be less than or equal to T_{coh}. As such, the DM RS-based CQI, rank indicator (RI), PMI, etc. for the semi-statically configured sub-bands Sᵢ may be reported by the mobile terminal 10 at the beginning of the coherence time interval T_{coh}. As such, the base station 14, such as the apparatus 40 may schedule DM RS as well as PDSCH if there is data to transmit to the mobile terminal, on sub-band Sᵢ via DL grants and schedule the UL grant for the sub-band CSI report by the mobile terminal.

In an instance in which the base station 14, such as the processing circuitry 42, the processor 44 or the like, determines that a significant change has occurred in the subband-based measurement report for a given sub-band Sᵢ between two consecutive report time intervals Tᵣₑₚₒᵣₜ, the base station, such as the processing circuitry, the processor or the like, may institute another CSI measurement setup phase to determine if the coherence time T_{coh} and bandwidth coherence B_{coh} have changed. The mobile terminal may determine that a significant change has occurred in various manners including by determining that the change exceeds a predetermined value, the change exceeds a predefined percent or the like. While this embodiment may be useful in various scenarios, one example of its utility is in an instance in which low mobile terminal mobility cannot be assumed.

In one embodiment, the CSI sub-band size B_{w} for sub-band Sᵢ in system bandwidth={S₁, S₂, . . . Sₙ} may be initially set to a relatively small number of PRBs, such as 6 PRBs. At the end of the CSI measurement setup time interval, however, the apparatus 40 may have estimated the coherence time T_{coh} and may be configured to further determine the coherence bandwidth B_{coh} based on the CSI correlation experience within L contiguous sub-bands. {S_{i-L/2}, Sᵢ, . . . S_{i+L/2-1}}. See optional operation 98 of FIG. 9. The apparatus may include means, such as the processing circuitry 42, the processor 44 or the like, for subsequently setting the CSI sub-band size B_{w} for sub-band Sᵢ equal to the coherence bandwidth B_{coh} to minimize CSI reporting overhead. See optional operation 100 of FIG. 9.

In one embodiment described above, the DM RS-based sub-band CSI reporting includes CQI, PMI and RI. In an instance in which the bands of the channel extension or channel segment are relative small, such as in comparison to the sub-bands of the component carriers of LTE Release 10, DM RS-based CQI may be based on the sub-band CQI feedback so as to maintain suitable performance while maintaining a reasonable overhead.

The base station 14 may utilize frequency domain packet scheduling to allocate PDSCH resources in configured sub-bands Sᵢ based on the CSI sub-band measurement reports for the remainder of the current coherence time interval T_{coh,n} and the beginning of the next coherence time interval T_{coh, n+1}. During the next coherence time interval, the next CS measurement report may be generated and provided by the mobile terminal 10. Advantageously, frequency domain packet scheduling for a channel extension or channel segment utilizing only DM RS may be performed following the initial setup based on the semi-static configuration of the DM RS based sub-band CSI reporting procedure.

The apparatus 40 of one embodiment may optimize further DM RS time frequency patterns based on the estimated coherence time T_{coh} and the coherence bandwidth B_{coh} via CSI-based estimation as described above in conjunction with the embodiment of FIG. 5. In this regard, the time-frequency DM RS pattern configuration in a channel extension or channel segment may be defined by the DM RS time density parameter M_{TD} and the DM RS frequency density parameter M_{FD}. In one embodiment, the DM RS pattern may be specific to a mobile terminal 10 configured to support mobile unit multiple input multiple output (MU MIMO) operations. In this regard, in the Release 10 of the LTE specification, MU-MIMO is transparent to the mobile terminal. For example, a first mobile terminal having a scheduled DM RS in a PRB set # S1 will not be aware if another mobile terminal also has a scheduled DM RS in the same or at least partially the same set of PRBs. In Release 10 of the LT specification, this issue is resolved by defining the DM RS sequence as a function of cell ID, but not mobile terminal ID, in the sub-carrier index. As such, the mobile terminals will have a more orthogonal DM RS sequence as long as the scrambling IDs are properly completed.

In accordance with one embodiment of the present invention, the base station 14 may be configured to insure that during the CSI measurement setup time interval T_{csi}_{_{—}}ₛₑₜᵤₚ if two mobile terminals 10 are scheduled on the same set of PRBs during the semi-static configuration of the DM RS sub-band CSI reporting for a channel extension or a channel segment, the DM RS patterns of these mobile terminals will be compatible with each other. This compatibility can be insured by the base station configuring the mobile terminal specific DM RS pattern as described above. Alternatively, MU MIMO may not be utilized during the CSI measurement setup time internal in order to avoid this issue.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
receiving information regarding a time-frequency reference signal pattern configuration in a carrier extension (CE) or a carrier segment (CS), wherein the time-frequency reference signal pattern configuration defines a subframe to include a reference signal based upon a time density parameter N_{TD} and defines a resource element to be utilized within the subframe based upon a frequency density parameter N_{FD}; and
receiving reference signals in accordance with the time-frequency reference signal pattern configuration such that the reference signals have a coherence time T_{coh} with at least one subframe including a reference signal in the CE or CS per T_{coh} and a coherence bandwidth B_{coh} with at least one resource element containing a reference signal per B_{coh}.

2. A method according to claim 1 wherein the reference signal comprises a cell-specific reference signal (CRS) or a demodulation reference signal (DM RS).

3. A method according to claim 1, further comprising:
estimating a coherence time and a coherence bandwidth; and
causing estimates of the coherence time and the coherence bandwidth to be reported to facilitate updating of the time-frequency reference signal pattern configuration.

4. A method according to claim 1, further comprising causing a channel quality indicator (CQI) or a precoding matrix indicator (PMI) to be reported to facilitate updating of the time-frequency reference signal pattern configuration.

5. A computer program product comprising at least one computer-readable storage medium having computer-executable program code instructions stored therein, the computer-executable program code instructions comprising program code instructions, when executed, for performing the method of claim 1.

6. An apparatus comprising:
at least one processor; and
at least one memory including computer program code, wherein the at least one memory and the computer program code are configured to, with the at least one processor, cause the apparatus at least to perform:
receiving information regarding a time-frequency reference signal pattern configuration in a carrier extension (CE) or a carrier segment (CS), wherein the time-frequency reference signal pattern configuration defines a subframe to include a reference signal based upon a time density parameter N_{TD} and defines a resource element to be utilized within the subframe based upon a frequency density parameter N_{FD}; and
receiving reference signals in accordance with the time-frequency reference signal pattern configuration such that the reference signals have a coherence time T_{coh} with at least one subframe including a reference signal in the CE or CS per T_{coh} and a coherence bandwidth B_{coh} with at least one resource element containing a reference signal per B_{coh}.

7. An apparatus according to claim 6 wherein the reference signal comprises a cell-specific reference signal (CRS) or a demodulation reference signal (DM RS).

8. An apparatus according to claim 6, wherein the at least one memory and the computer program code are further configured to, with the at least one processor, cause the apparatus to:
estimate a coherence time and a coherence bandwidth; and
cause estimates of the coherence time and the coherence bandwidth to be reported to facilitate updating of the time-frequency reference signal pattern configuration.

9. An apparatus according to claim 6, wherein the at least one memory and the computer program code are further configured to, with the at least one processor, cause the apparatus to cause a channel quality indicator (CQI) or a precoding matrix indicator (PMI) to be reported to facilitate updating of the time-frequency reference signal pattern configuration.

10. An apparatus according to claim 6, wherein the at least one processor; and the at least one memory are embodied in a mobile terminal.

11. (canceled)

12. An apparatus according to claim 6, wherein the at least one memory and the computer program code are configured to, with the at least one processor, cause the apparatus to provide for communications by providing for communications in a Long Term Evolution (LTE) system.

13-17. (canceled)

18. An apparatus comprising:
at least one processor; and
at least one memory including computer program code, wherein the at least one memory and the computer program code are configured to, with the at least one processor, cause the apparatus at least to perform:
defining a time-frequency reference signal pattern configuration in a carrier extension (CE) or a carrier segment (CS) to have density parameters including a time density parameter N_{TD} that defines a subframe to include a reference signal and a frequency density parameter N_{FD} that defines a resource element to be utilized within the subframe; and
in an instance in which a neighboring base station has a time-frequency reference signal pattern configuration with a respective density parameter that is the same, coordinating the reference signal patterns by offsetting the reference signal pattern.

19. An apparatus according to claim 18 wherein the at least one memory and the computer program code are further configured to, with the at least one processor, cause the apparatus to, in an instance in which the neighboring base stations have time-frequency reference signal pattern configurations with the respective density pattern being different, coordinate the reference signal patterns by shifting the reference signal pattern.

20. An apparatus according to claim 18, wherein the reference signal comprises a cell-specific reference signal (CRS) or a demodulation reference signal (DM RS).

21. An apparatus according to claim 18, wherein the at least one memory and the computer program code are further configured to, with the at least one processor, cause the apparatus to define the time-frequency reference signal pattern to define a blank subframe and utilize the blank subframe for inter-cell interference coordination (ICIC) or non-cellular interference measurements.

22. An apparatus according to claim 18, wherein the at least one processor; and the at least one memory are embodied in a base station.

23-28. (canceled)

29. The apparatus according to claim 18, wherein the at least one memory and the computer program code are configured to, with the at least one processor, cause the apparatus at least to further perform:
receiving a report of a channel quality indicator (CQI) or a precoding matrix indicator (PMI) for a subband Sᵢ for each of a plurality of channel state information (CSI) measurement time intervals T_{Δ};
determining a number n of consecutive intervals T_{Δ} over which the report of the CQI or the PMI remains consistent; and
determining a subband CSI measurement report periodicity for the subband Sᵢ based upon a product of the number n and the interval T_{Δ}.

30. An apparatus according to claim 29 wherein the product of the number n and the interval T_{Δ} is less than a coherence time T_{coh}.

31. An apparatus according to claim 29, wherein the at least one memory and the computer program code are further configured to, with the at least one processor, cause the apparatus to cause the subband CSI measurement report periodicity to be provided to a mobile terminal.

32. An apparatus according to claim 29, wherein the at least one memory and the computer program code are further configured to, with the at least one processor, cause the apparatus to determine a coherence bandwidth B_{coh} and set a CSI subband size B_{w} for subband Sᵢ equal to B_{coh}.

33-34. (canceled)
